(19) United States
(12) Patent Application Publication
(10) Pub. No.: US 2026/0057269 A1
(43) Pub. Date: Feb. 26, 2026

(54) Systems and Methods for Efficient Synchronization for Fault-Tolerant Quantum Computers

(71) Applicant: Wisconsin Alumni Research Foundation (WARF), Madison, WI (US)

(72) Inventors: Swamit TANNU, Madison, WI (US); Satvik MAURYA, Madison, WI (US)

(21) Appl. No.: 18/793,031

(22) Filed: Aug. 2, 2024

(51) Int. Cl. G06N 10/20; G06N 10/70

(52) U.S. Cl. CPC G06N 10/20; G06N 10/70

(57) ABSTRACT

A system for logical patch synchronization includes a quantum computer, a processor, and a memory. The memory includes instructions stored thereon, which when executed by the processor cause the system to: determine a synchronization slack between two or more logical patches of the quantum computer that are to undergo a lattice surgery operation; determine time elapsed in a code cycle for a logical patch of the two or more logical patches; generate patch counter information; access patch counter information and patch metadata from a patch metadata table; determine the synchronization slack to be added to a schedule; determine the difference in an execution phase of the patches through a phase calculator to determine a fastest patch and a slowest patch; and perform a correction by synchronizing the patches based on inserting, by a synchronization slack calculator, a barrier in the schedule, based on the determined fastest patch and slowest patch.

### STATEMENT REGARDING GOVERNMENT SUPPORT

This invention was made with government support under 2212232 awarded by the National Science Foundation. The government has certain rights in the invention.

### FIELD OF THE DISCLOSURE

The present disclosure relates to the field of quantum computing and, more particularly, to methods of improving error correction.

### BACKGROUND

Scalable, universal quantum computers have the potential to outperform classical computers for a range of tasks. However, the inherent fragility of quantum states and the finite fidelity of physical qubit operations make errors unavoidable in any quantum computation. Quantum error correction allows multiple physical qubits to represent a single logical qubit, such that the correct logical state can be recovered even in the presence of errors on the underlying physical qubits and gate operations. If the logical qubit operations are implemented in a fault-tolerant manner that prevents the proliferation of correlated errors, the logical error rate can be suppressed arbitrarily so long as the error probability during each operation is below a threshold. Universal fault-tolerant quantum computing can require hundreds of logical qubits, which translates to tens of thousands of physical qubits. Quantum computing systems are not perfect; that is, gate and readout latencies can be non-uniform across the lattice, decoder latencies are non-deterministic, and multiple classical controllers used for controlling different logical qubits can have a skew between them.

### SUMMARY

An aspect of the present disclosure provides a system for logical patch synchronization, including: a quantum computer; a processor; and a memory. The memory includes instructions stored thereon, which when executed by the processor cause the system to: determine a synchronization slack between two or more logical patches of the quantum computer that are to undergo at least one of a lattice surgery, a braiding, and/or a transversal gate operation; determine a time elapsed in a code cycle for a logical patch of the two or more logical patches; generate patch counter information; access, by a synchronization engine, patch counter information and patch metadata from a patch metadata table of the two or more logical patches, wherein the patch metadata includes a cycle duration of every logical patch; determine by the synchronization engine the synchronization slack to be added to a schedule; determine the difference in an execution phase of the patches through a phase calculator to determine a fastest patch and a slowest patch; and perform a correction by synchronizing the two or more logical patches based on inserting, by a synchronization slack calculator, a barrier in the schedule, based on the determined fastest patch and slowest patch.

In an aspect of the present disclosure, the instructions, when executed by the processor, may further cause the system to distribute the synchronization slack within the code cycle by interleaving gates and idle periods.

In another aspect of the present disclosure, the instructions, when executed by the processor, may further cause the system to: determine the synchronization slack between the two or more logical patches by finding a difference between a time left in completing the code cycle of the two or more logical patches. The slack may be divided equally between a number of gate layers of the schedule in the form of a blocking barrier.

In yet another aspect of the present disclosure, the system may maintain a counter for every logical patch.

In a further aspect of the present disclosure, the system may further include a counter for each logical patch. The instructions, when executed by the processor, may further cause the system to: increment each counter at every tick of a global clock; start and end each counter with a surface code cycle for its corresponding patch; merge or split a patch to yield one or more different patches; and disable the respective counter for a former patch.

In yet a further aspect of the present disclosure, the instructions, when executed by the processor, may further cause the system to update the patch metadata after every lattice surgery operation of a plurality of lattice surgery operations.

In another aspect of the present disclosure, the instructions, when executed by the processor, may further cause the system to perform the correction after every lattice surgery of the plurality of lattice surgery operations based on the updated patch metadata.

In yet another aspect of the present disclosure, the patch counter information may include information on bit validity indicating whether the logical patch is a valid logical patch or an invalid logical patch.

In a further aspect of the present disclosure, the instructions, when executed by the processor, may further cause the system to introduce idle periods required for synchronizing the two or more logical patches within an additional surface code cycle.

In yet a further aspect of the present disclosure, the patch counter information includes a number of rounds completed for the two or more logical patches.

In accordance with aspects of the disclosure, a processor-implemented method for logical qubit synchronization, includes: determining a synchronization slack between two or more logical patches of a quantum computer that are to undergo a lattice surgery operation; determining a time elapsed in a code cycle for a logical patch of the two or more logical patches; generate patch counter information, wherein the patch counter information includes a number of rounds completed for the two or more logical patches; accessing, by a synchronization engine, patch counter information and patch metadata from a patch metadata table and the patch counter table of the two or more logical patches, wherein the patch metadata includes a cycle duration of every logical patch; determining by the synchronization engine the synchronization slack to be added to a schedule; determining the difference in an execution phase of the patches through a phase calculator to determine a fastest patch and a slowest patch; and performing a correction by synchronizing the two or more logical patches based on inserting, by a synchronization slack calculator, a barrier in the schedule, based on the determined fastest patch and slowest patch.

In yet another aspect of the present disclosure, the method may further include distributing the synchronization slack within the code cycle by interleaving gates and idle periods.

In a further aspect of the present disclosure, the method may further include determining the synchronization slack between the two or more logical patches by finding a difference between a time left in completing the code cycle of the two or more logical patches. The slack is divided equally between the number of gate layers of the schedule in the form of a blocking barrier.

In yet a further aspect of the present disclosure, the method may further include maintaining a counter for every logical patch.

In a further aspect of the present disclosure, the method may further include: incrementing a counter for each logical patch at every tick of a global clock; starting and ending each counter with a surface code cycle for its corresponding patch; merging or splitting a patch to yield one or more different patches; and disabling the respective counter for a former patch.

In yet a further aspect of the present disclosure, the method may further include updating the patch metadata after every lattice surgery operation of a plurality of lattice surgery operations.

In a further aspect of the present disclosure, the method may further include performing the correction after every lattice surgery of the plurality of lattice surgery operations based on the updated patch metadata.

In yet a further aspect of the present disclosure, the patch counter information may include information on bit validity indicating whether the logical patch is a valid logical patch or an invalid logical patch.

In yet a further aspect of the present disclosure, the method may further include introducing idle periods required for synchronizing the two or more logical patches within an additional surface code cycle.

In accordance with aspects of the disclosure, a non-transitory computer readable medium storing a program that causes a computer to execute a processor-implemented method for logical qubit synchronization, includes: determining a synchronization slack between two or more logical patches of a quantum computer that are to undergo a lattice surgery operation; determining a time elapsed in a code cycle for a logical patch of the two or more logical patches; generate patch counter information, wherein the patch counter information includes a number of rounds completed for the two or more logical patches; accessing, by a synchronization engine, patch counter information and patch metadata from a patch metadata table and the patch counter table of the two or more logical patches, wherein the patch metadata includes a cycle duration of every logical patch; determining by the synchronization engine the synchronization slack to be added to a schedule; determining the difference in an execution phase of the patches through a phase calculator to determine a fastest patch and a slowest patch; and performing a correction by synchronizing the two or more logical patches based on inserting, by a synchronization slack calculator, a barrier in the schedule, based on the determined fastest patch and slowest patch.

In accordance with aspects of the disclosure, a system for logical patch synchronization, includes a quantum computer; a processor; and a memory. The memory includes instructions stored thereon, which when executed by the processor cause the system to: determine a synchronization slack between two or more logical patches of the quantum computer that are to undergo a lattice surgery operation; determine a time elapsed in a code cycle for a logical patch of the two or more logical patches; generate patch counter information; access, by a synchronization engine, patch counter information and patch metadata from a patch metadata table of the two or more logical patches, wherein the patch metadata includes a cycle duration of every logical patch; determine by the synchronization engine the synchronization slack to be added to a schedule; determine the difference in an execution phase of the patches through a phase calculator to determine a fastest patch and a slowest patch; and perform a correction by synchronizing the two or more logical patches based on inserting, by a synchronization slack calculator, a barrier in the schedule, based on the determined fastest patch and slowest patch. The barrier is subdivided into a plurality of portions based on a number of rounds and each of the plurality of portions is inserted between rounds.

### BRIEF DESCRIPTION OF THE DRAWINGS

A better understanding of the features and advantages of the present disclosure will be obtained by reference to the following detailed description that sets forth illustrative aspects, in which the principles of the present disclosure are utilized, and the accompanying drawings of which:

FIG. 1 is a block diagram illustrating an exemplary system for logical patch synchronization for quantum computers, in accordance with examples of the present disclosure;

FIG. 2 is a schematic diagram of an exemplary processing system diagram for use with the system of FIG. 1, in accordance with examples of the present disclosure;

FIG. 3 is a timeline for a lattice surgery merge operation for two logical patches of a quantum computer, with two skewed patches, of the system of FIG. 1, in accordance with examples of the present disclosure;

FIG. 4 is a detailed view of stabilizer circuits of the two skewed logical patches of FIG. 3, in accordance with examples of the present disclosure;

FIG. 5 is a diagram illustrating active synchronization implemented by the system of FIG. 1, compared against passive synchronization, in accordance with examples of the present disclosure;

FIG. 6 is a block diagram illustrating a synchronization engine of the system of FIG. 1, in accordance with examples of the present disclosure;

FIG. 7 is a diagram illustrating an example logical patch, in accordance with examples of the present disclosure;

FIG. 8 is a diagram illustrating the interactions between the data qubits and measure qubits for the surface code, in accordance with examples of the present disclosure;

FIG. 9 is a flow diagram for a method for logical patch synchronization for quantum computers using the system of FIG. 1, in accordance with examples of the present disclosure;

FIG. 10 is a diagram illustrating logical patch movement, in accordance with examples of the present disclosure;

FIG. 11 is a diagram illustrating long range CNOTs in a logical patch, in accordance with examples of the present disclosure;

FIG. 12 is a graph illustrating the number of magic states consumed for given benchmarks, in accordance with examples of the present disclosure;

FIG. 13 is a graph illustrating the estimation of the number of synchronizations required for generating the required magic states of FIG. 12, in accordance with examples of the present disclosure;

FIG. 14 is a diagram illustrating the consumption of magic states with lattice surgery, in accordance with examples of the present disclosure;

FIG. 15 is a diagram illustrating a spread of decoding latencies for a given code distance, in accordance with examples of the present disclosure;

FIG. 16 is a diagram illustrating an algorithm for active synchronization of two logical patches, in accordance with examples of the present disclosure;

FIG. 17 is the algorithm for active synchronization of two logical patches of FIG. 16, in accordance with examples of the present disclosure;

FIG. 18 is a diagram illustrating an algorithm for active synchronization of an arbitrary number of logical patches, in accordance with examples of the present disclosure;

FIG. 19 is the algorithm for active synchronization of an arbitrary number of logical patches of FIG. 18, in accordance with examples of the present disclosure;

FIGS. 20-23 are graphs illustrating the improvements in the logical error rate when using the active synchronization of the system of FIG. 1, in accordance with examples of the present disclosure;

FIG. 24 is a set of graphs illustrating the logical error rate for three systems, in accordance with examples of the present disclosure;

FIG. 25 is a set of graphs illustrating the improvement in the logical error rate compared to an ideal case where there are no defects in the lattice, in accordance with examples of the present disclosure;

FIGS. 26 and 27 are graphs illustrating a relative speedup of active synchronization over passive synchronization due to the reduction in error rate, in accordance with examples of the present disclosure;

FIGS. 28 and 29 are diagrams illustrating performing synchronization by distributing the slack between multiple cycles using the system of FIG. 1, in accordance with examples of the present disclosure.

### DETAILED DESCRIPTION

Although the present disclosure will be described in terms of specific examples, it will be readily apparent to those skilled in this art that various modifications, rearrangements, and substitutions may be made without departing from the spirit of the present disclosure. The scope of the present disclosure is defined by the claims appended hereto.

For purposes of promoting an understanding of the principles of the present disclosure, reference will now be made to exemplary aspects illustrated in the drawings, and specific language will be used to describe the same. It will nevertheless be understood that no limitation of the scope of the present disclosure is thereby intended. Any alterations and further modifications of the novel features illustrated herein, and any additional applications of the principles of the present disclosure as illustrated herein, which would occur to one skilled in the relevant art and having possession of this disclosure, are to be considered within the scope of the present disclosure.

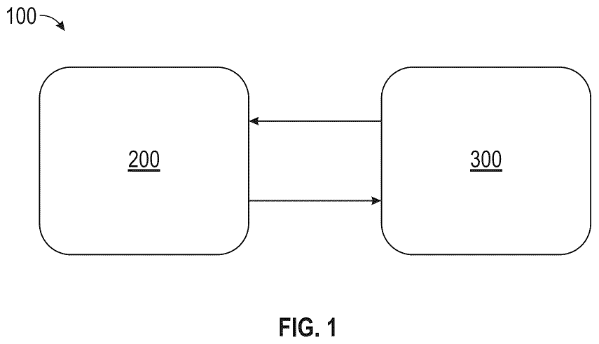

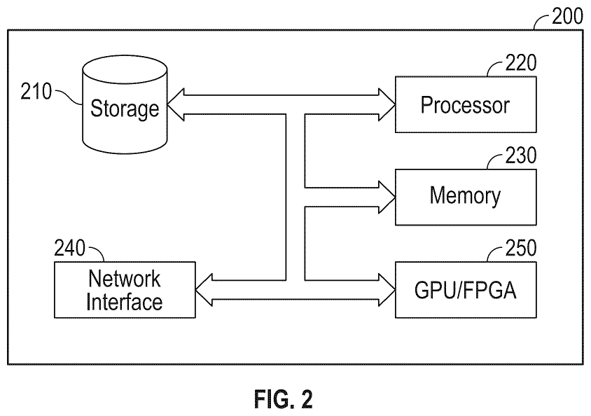

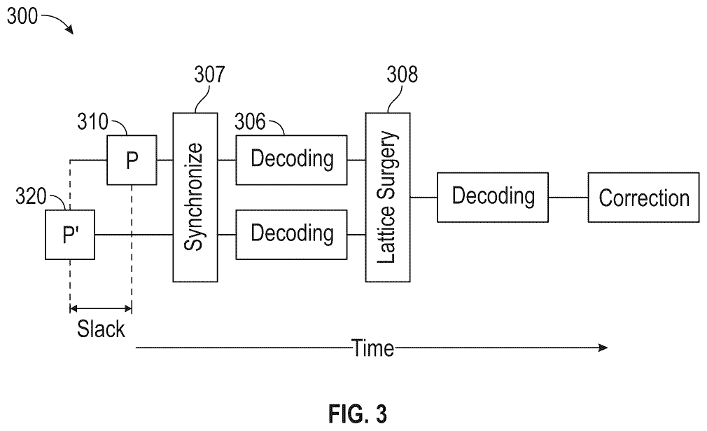

Referring to FIG. 1, a block diagram illustrating a system 100 for logical qubit synchronization is shown. System 100 generally includes a quantum computer 300 and a controller 200 (FIG. 2). The system 100 is configured for runtime active synchronization of one or more logical patches 310, 320 (i.e., logical qubit) (FIG. 3). To perform lattice surgery, quantum error correction (QEC) cycles of logical qubits are synchronized at runtime, which can be achieved by idling the leading logical qubit without running the QEC cycle. Unfortunately, idle qubits can cause significant errors and impair the effectiveness of the surface code. Active synchronization distributes the synchronization slack within the code cycle, thus reducing the impact of idling errors during synchronization. This approach leads to an improvement of up to 2.4 times in the logical error rate compared to a policy that makes the leading logical qubit wait until synchronization is complete. Active synchronization can prevent idling error buildup, thereby reducing the decoder effort and the decoder latency for subsequent rounds, thus yielding a speedup of up to 2.2 times per lattice surgery operation. As scalable and modular Fault-Tolerant Quantum Computer (FTQC) systems are built, synchronization becomes an increasingly important aspect requiring detailed study. Systems in accordance with the present disclosure take a step toward this broader goal by understanding synchronization overheads and building a simulator infrastructure that enables methodical analysis of logical operations performed via lattice surgery. Although lattice surgery is used as an example, the system may be applied to any of lattice surgery, braiding, and/or a transversal gate operations.

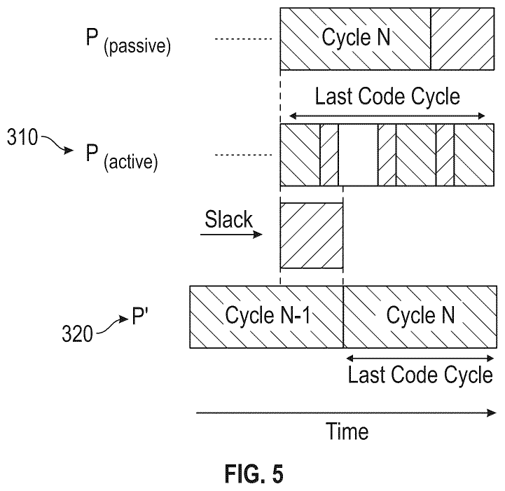

Non-uniform gate latencies and unpredictable decoding latencies on real hardware introduce a slack (phase difference) between logical qubits. The leading logical qubit stays idle to absorb this slack to match the phases of two logical qubits. To reduce the impact of idling errors incurred during synchronization, an active synchronization policy is utilized by system 100 that proactively distributes the slack involved in synchronization within the code cycle by interleaving gates and smaller idle periods as shown in FIG. 5, thereby running error correction during synchronization, albeit at a slower rate. The system may estimate how long the idle period should be.

The synchronization slack is the difference in the execution phases of the syndrome circuit of two (or more) patches. A patch can be out-of-sync with another patch if it is executing a different layer of gates in the syndrome circuit schedule. The syndrome circuit schedule refers to the timing and sequence of operations involved in measuring and processing syndromes. The worst-case synchronization slack between two patches will be the case where one patch is at the beginning of its syndrome generation cycle and the second patch is approaching the end of its cycle.

A code cycle refers to the sequence of operations performed to protect quantum information from errors using quantum error correction (QEC) codes. Quantum error correction is used because quantum bits (qubits) are highly susceptible to various types of errors due to decoherence, gate errors, and measurement errors.

Using an active synchronization policy, up to about a 2.4 times improvement in the logical error rate has been observed. In the presence of defects in the lattice, which cause lower coherence times, active synchronization can improve the logical error rate by up to about 2.6 times over the passive policy.

Beyond the logical error rate, active synchronization improves performance. Evaluations show idling errors increase decoding effort and, thereby, increase decoder latency. With approximately a 20% increase in the error rate, the decoder latency can increase by more than about 40%. This indicates that if the passive policy is used, additional errors incurred due to synchronization will slow down subsequent decoding.

To quantify the slowdown in the system, an evaluation was performed using a hierarchical decoder that used a lookup table (LUT)-based decoder, as the fast, first-level decoder and a minimum weight perfect matching (MWPM) decoder as the slower, accurate decoder. The size of the LUT was limited to perform realistic experiments. Because of additional errors incurred by the passive synchronization policy, the efficacy of the LUT is reduced, which translates to a speedup of over about 2.2 times per lattice surgery operation when active synchronization is used.

As quantum computers increase in size, a shift from monolithic to distributed architectures with chiplets is anticipated due to constraints on area, power, and control complexity. Future quantum platforms are expected to be networked, facilitating long range controlled NOT gates (CNOTs) through the transmission of entangled photons across nodes, which would be significantly slower than regular CNOTs, adding to sources of non-uniformity and need for building effective synchronization policies.

In quantum circuits, passive synchronization and idling during synchronization can substantially increase logical error rates. System 100 provides the technical solution to the problem of idling errors by using active synchronization to proactively synchronize logical qubits and reduce idling errors.

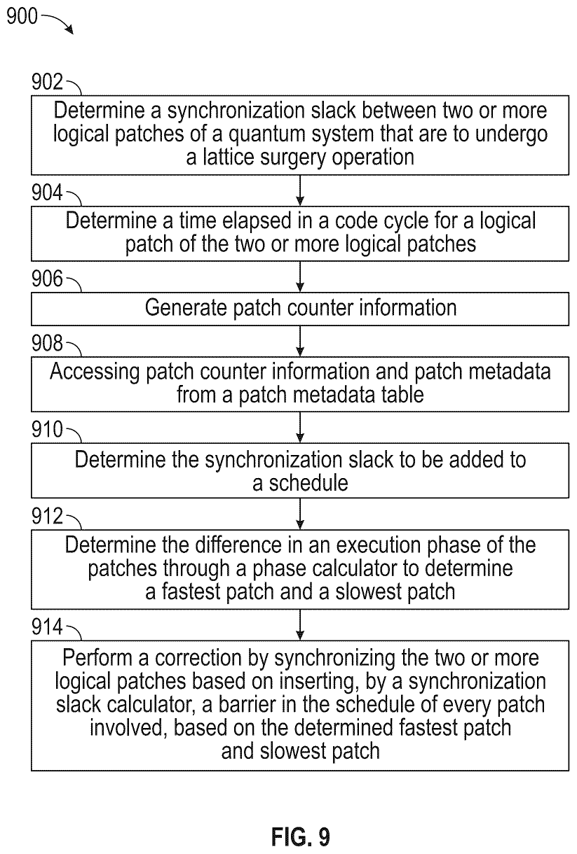

Referring now to FIG. 2, exemplary components of the controller 200 are shown. The controller 200 generally includes a storage or database 210, one or more processors 220, at least one memory 230, and a network interface 240. In aspects, the controller 200 may include a graphical processing unit (GPU) 250. The processor 220 and a memory 230 include instructions stored thereon, which, when executed by the processor 220, cause the system 100 to perform the steps of method 900 of FIG. 9.

The database 210 can be located in storage. The term “storage” may refer to any device or material from which information may be capable of being accessed, reproduced, and/or held in an electromagnetic or optical form for access by a computer processor. Storage may be, for example, volatile memory such as RAM, non-volatile memory, which permanently holds digital data until purposely erased, such as flash memory, magnetic devices such as hard disk drives, and optical media such as a CD, DVD, Blu-ray Disc™, or the like.

In aspects, data may be stored on the controller 200, including, for example, user accounts, permissions, licensing documentation, and/or other data. The data can be stored in the database 210 and sent via a system bus to the processor 220.

As will be described in more detail later herein, the processor 220 executes various processes based on instructions that can be stored in the at least one memory 230 and utilizing the data from the database 210. The illustration of FIG. 2 is exemplary, and persons skilled in the art will understand that other components may exist in controller 200. Such other components are not illustrated for clarity of illustration.

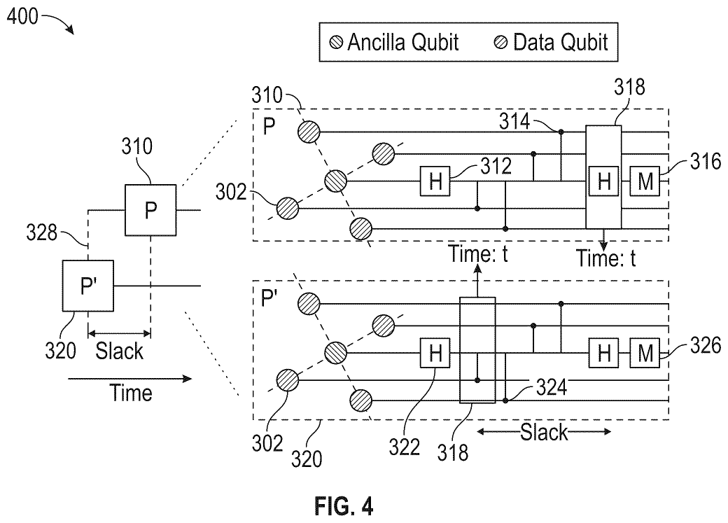

Referring to FIG. 3, a diagram illustrating an example timeline for a lattice surgery merge operation 308 for two skewed logical patches 310, 320 of a quantum computer 300 is shown. Prior to the lattice surgery operation, the two patches P 310 and P′ 320 have to be synchronized after which their syndromes can be decoded 306. Immediately after synchronization 307, the lattice surgery operation can commence for a minimum number of rounds before errors in the merged patch can be decoded. Based on this decoding result and the decoding result of the patches prior to merge, an appropriate correction can be determined Referring to FIG. 4, a diagram illustrating the impact of non-uniform latencies on the logical qubits is shown. P′ 320 is lagging behind P 310, thus introducing a slack 328 between the two logical qubits that are absorbed before performing lattice surgery.

An expanded view of the stabilizer circuits of the two skewed patches in FIG. 3 is shown in FIG. 4. P 310 at the time (t) 318 is executing the final layer of Hadamard gates, while P′ 310 at the time (t) 318 is on the first CNOT 324 (controlled-NOT) layer.

Referring to FIG. 5, a diagram illustrating active synchronization, as implemented by system 100, compared to passive synchronization, is shown. With active synchronization, the slack between P and P′ is distributed evenly within the leading patch P. With passive synchronization, the slack is bunched up at the end of the code cycle.

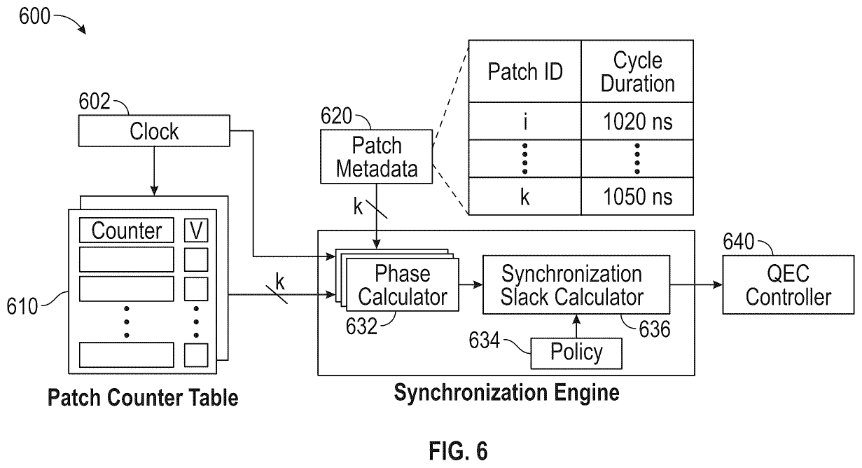

Referring to FIG. 6, a synchronization engine 600 of system 100 of FIG. 1 is shown. Synchronization engine 600 is configured to enable active synchronization of two or more logical patches. Synchronization engine 600 may be executed by controller 200. Synchronization engine 600 generally determines the synchronization slack that needs to be added to the schedule. Synchronization engine 600 generally includes a phase calculator 632 configured to determine the fastest and slowest patch, a synchronization slack calculator 636 configured to determine appropriate barriers based on the fastest and slowest patch, a quantum error correction controller 640 configured to inset barriers as determined by synchronization slack calculator 636, a patch counter table 610, and patch metadata table 620.

Determining the synchronization slack between two or more logical patches requires the knowledge of (i) the cycle duration of each patch (T), and (ii) the time elapsed in the current code cycle for each patch (t). The cycle duration depends on the gate and measurement latencies of a stabilizer circuit of the quantum computer which in turn are dependent on the physical qubits that constitute a patch. Since lattice surgery modifies the shape and position of patches during computation, the cycle duration of a patch can keep changing. Assuming that the physical qubits in the lattice are calibrated regularly, the cycle duration of all patches required for computation (in time and space) can be computed and stored in a table during compilation time. This is possible since lattice surgery compilers can generate an intermediate representation (IR) of all lattice surgery operations required to implement a circuit. Since patches are merged/split to create new patches, the entire IR can be used to map physical qubits to their corresponding logical patches from which the cycle duration can be determined.

Synchronization engine 600 determines the time elapsed in the current code cycle (t) for every patch that needs to be synchronized based on maintaining counters for every logical patch in quantum computer 300 to keep track of the current phase of every logical patch in quantum computer 300. Each counter increments at every tick of a global clock 602. Each counter starts and ends with the surface code cycle for its corresponding logical patch. Once a logical patch has been merged or split to yield a different logical patch(s), the counter for the former patch can be disabled. Since surface code cycles for superconducting qubits can lie between about 1000 ns to about 2000 ns and assuming a clock frequency of 1 GHz, 10 to 12 bit counters per logical patch may be used to determine (t).

Patch counter table 610 generally includes information indicating a number of rounds completed for every logical patch, and a validity bit which specifies whether the logical patch is a valid patch or not. Lattice surgery operations can invalidate a patch. For example, after merging two or more patches, only one patch remains. Patch metadata table 620 generally includes metadata, for example, information on a cycle duration of every logical patch (e.g., 1020 ns for patch i).

Phase calculator 632 is configured to determine the fastest and slowest patch. The information from the patch metadata table 620 and the patch counter table 610 of the k patches that need to be synchronized is passed to the phase calculator 632 and is used to determine a difference in an execution phase of the two or more logical patches.

Synchronization slack calculator 636 determines the appropriate barriers to insert in the schedule of every logical patch involved to synchronize the logical patches based on the difference in an execution phase of the two or more logical patches as determined by phase calculator 632. In the context of lattice surgery, barriers refer to specific points in the quantum circuit where certain operations or measurements are applied to ensure the correct execution and integrity of the quantum computation. Barriers may serve as synchronization points in the quantum circuit. Quantum operations are highly sensitive to timing and phase coherence. Barriers ensure that certain operations on different qubits or parts of the quantum state are performed at the correct times relative to each other, minimizing errors due to timing misalignment. In lattice surgery, where quantum information is encoded and manipulated using an error-correcting code (e.g., surface code), barriers may help in applying stabilizer measurements and corrections. In quantum error correction schemes like surface code, logical qubits are encoded in a larger set of physical qubits. Barriers help in isolating and protecting these logical qubits during operations such as syndrome measurements and logical operations.

System 100 updates patch metadata after every lattice surgery operation, since the cycle duration of a patch will change after every split and merge operation. The synchronized schedule is then passed to the quantum error correction controller 640 for execution. Quantum error correction controller 640 is instructed by synchronization slack calculator 636 to insert the barriers in the schedule for synchronization.

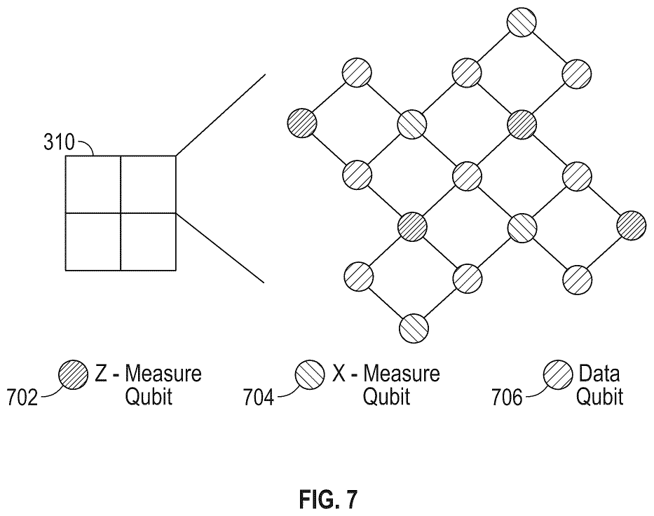

Referring to FIG. 7, an example logical patch 310 is shown. Logical patch 310 (e.g., a logical qubit) is composed of a fixed arrangement of physical qubits. The physical qubits are categorized as data qubits 706, X-measure qubits 704, and Z-measure qubits 702. The number of X-measure qubits 704, Z-measure qubits 702, and data qubits 706 needed to define a single logical qubit is dependent on a code distance of the surface code. The code distance is a measure of the number of errors that can be corrected. The use of the rotated lattice is assumed, which consists of d² data qubits and d²−1 measure qubits for a code distance of d. A logical qubit with code distance d can correct (d−1)/2 errors by repeating d rounds of stabilizer circuit.

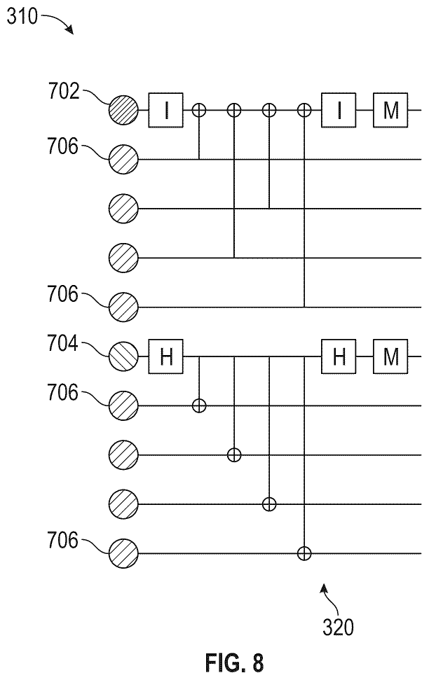

Referring to FIG. 8, the interactions between the data qubits and measure qubits for the surface code are shown. For every X-measure qubit and Z-measure qubit in the patch, all gate operations are performed in lockstep, such that gates across a large physical lattice are executed in parallel for all measure qubits in a patch. This level of concurrency is supported to prevent qubits from idling and thus incurring errors. A surface code cycle ends with the measurement of the X-measure qubit and Z-measure qubit, and multiple code cycles are needed to detect errors accurately.

Lattice surgery operations include merge operations and split operations. The merge operation fuses two logical qubits to produce a single logical qubit whose state depends on the states of the two logical qubits that were merged. Note that a merge introduces new interactions between the measure and data qubits of the two patches, and these interactions have to be synchronized with the other interactions in the two patches. The split operation splits a logical qubit into two. Note that the patch being split is sufficiently large such that the code distance is maintained. All logical multi-qubit operations can be decomposed into a sequence of merge, split, and measurement operations.

Referring to FIG. 9, a method 900 for logical patch synchronization for quantum computers using the system of FIG. 1 is shown. The system 100 for logical patch synchronization for quantum computers may include a processor and a memory, including instructions stored thereon, which when executed by the processor 220, cause the quantum computer 300 to perform the steps of method 900. Some operations may be performed on a classical computer, such as controller 200.

Initially, at step 902, the processor causes the system 100 to determine a synchronization slack between two or more logical patches of a quantum computer 300 that are to undergo a lattice surgery operation.

At step 904, the processor causes the system 100 to determine a time elapsed in a code cycle for a logical patch of the two or more logical patches.

At step 906, the processor causes the system 100 to generate patch counter information and store the patch counter information in a patch counter table. The patch counter information may include a number of rounds completed for the two or more logical patches.

At step 908, the processor causes the system 100 to access, by a synchronization engine, patch counter information and patch metadata from a patch metadata table. Patch metadata may include a cycle duration of every logical patch.

At step 910, the processor causes the system 100 to determine by the synchronization engine the synchronization slack to be added to a schedule.

At step 912, the processor causes the system 100 to determine the difference in an execution phase of the patches through a phase calculator to determine a fastest patch and a slowest patch.

At step 914, the processor causes the system 100 to perform a correction by synchronizing the two or more logical patches based on inserting, by a synchronization slack calculator, a barrier in the schedule, based on the determined fastest patch and slowest patch.

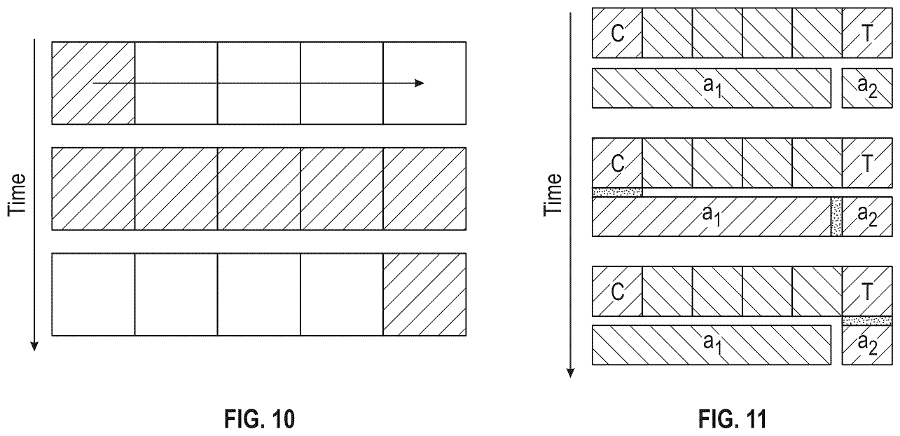

Referring to FIG. 10 a diagram illustrating logical patch movement is shown.

Quantum computers running surface code are envisioned to have a “sea of qubits architecture,” where a lattice of physical qubits is partitioned into patches of logical qubits. There are two types of qubit patches: logical data patches and logical ancillary patches. Data qubit patches hold data variables described in the algorithm, while ancillary patches facilitate logical operations. FIG. 10 shows a total of five patches. The filled patch in the top panel corresponds to data qubits, and unfilled patches are ancillary qubits. All FTQC algorithms involve operations that span multiple patches. For performing multi-patch operations, patches should be synchronized. There are three broad categories of multi-patch operations: 1) moving patches, 2) long-range CNOTs, and 3) consuming magic states.

Lattice surgery allows the movement of logical qubits across the lattice. As shown in FIG. 10, the movement of a patch involves merging the logical qubit to expand it with the empty ancillary patches with the destination patch. This expanded patch is measured for d code cycles, after which the extra qubits are measured out. Patches might need to be moved to enable other logical operations like CNOTs, for moving magic states to a region where they can be consumed by other logical qubits or to move a patch away from a more error-prone region of the lattice. Since the expanded patch is composed of smaller patches that may or may not have the same controller, it is necessary for the patches to be synchronized during the operation.

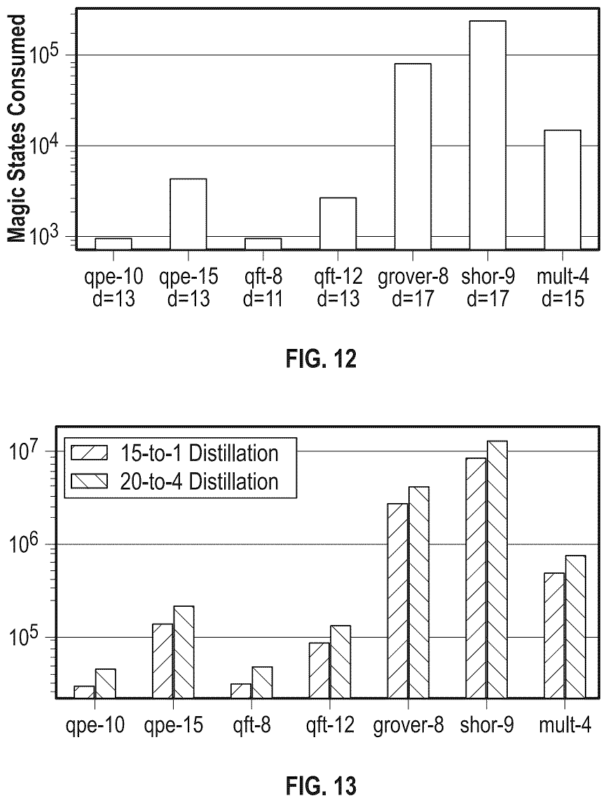

CNOTs are used frequently in distillation factories for generating T states. Often, the logical patches are not in the same vicinity, necessitating long-range CNOTs that span multiple patches in the lattice. Additionally, distillation factories can be made more resource efficient and faster by using multi-target CNOTs. FIG. 11 illustrates how a long-range CNOT can be performed between the Control (C) patch and the Target (T) patch which are separated by numerous patches by using lattice surgery. The two ancilla qubits are first merged with the Control patch after which the second ancilla is merged with the Target patch. Long range CNOTs can require arbitrarily large ancilla qubits that span multiple logical patches.

Magic state distillation is the most resource and time intensive operation in a fault-tolerant quantum computer. Magic state distillation is used to prepare high-quality magic states, which are purified forms of the non-Clifford T state. Distillation is performed in dedicated regions of the lattice called the T factories, which continuously produce magic states for consumption by the algorithmic logical qubits. Distillation protocols via lattice surgery utilize patch movement and long-range CNOTs to produce magic states. Moreover, the consumption of magic states also involves multi-patch operations in the form of Pauli-product measurements. Magic state distillation is the most resource intensive component of a fault-tolerant architecture. The number of qubits required by T factories implies that the algorithmic logical qubits can be significantly far from the T factories that produce the magic states.

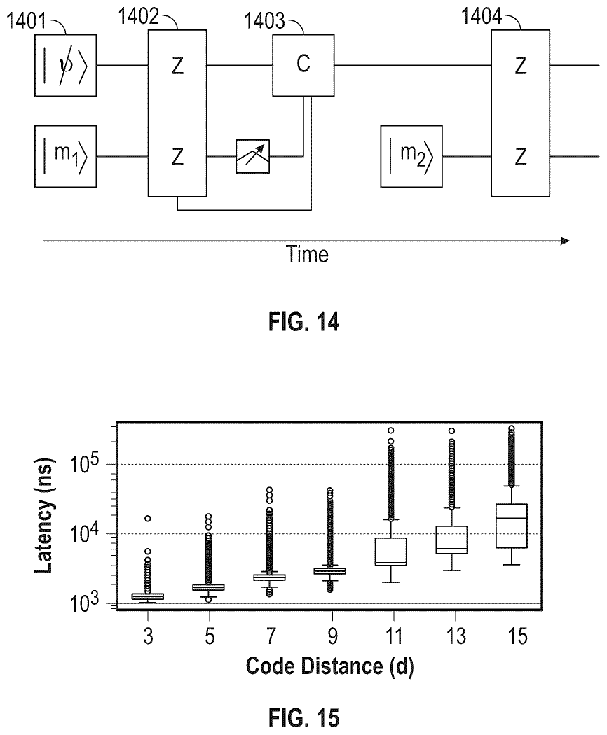

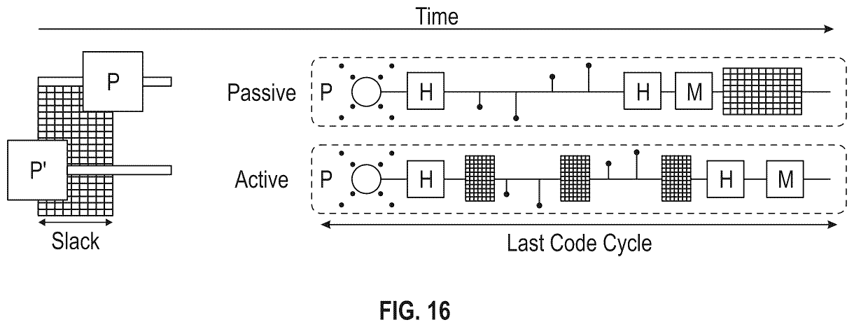

FIG. 12 is a graph illustrating the number of magic states consumed by the different workloads. Even small benchmarks like QFT-8 (quantum Fourier transform 8) consume a large number of magic states, which in turn require just as many multi-patch operations (FIG. 13).

Synchronization will necessitate that one or more patches pause or slow down to synchronize them with the others. For a successful merge operation, all patches in the merged patch starts their syndrome generation cycle at the same time. Prior to the merge, if a patch P completes its current cycle and starts a new syndrome generation cycle before the other patch P′ complete its current cycle, starting a new cycle for the merged patch will be impossible if P has executed one or more entangling gates in its new cycle by the time P′ completes its current cycle. If P does not wait for P′ to complete its current cycle, P′ will have to wait for P to complete/rollback the new cycle it had started, thus necessitating a pause in syndrome generation for synchronization.

The large number of qubits required for implementing universal fault-tolerant quantum computers will require a modular, distributed organization for both the qubits themselves and the control hardware required for those qubits. For superconducting qubits, chiplet architectures for scaling quantum hardware have been proposed and future roadmaps also incorporate tiled architectures to scale up the number of qubits. With such a distributed architecture of both qubits and control hardware, implementing logical operations using lattice surgery becomes a more complicated problem as multi-patch operations can span boundaries of controllers too. As an example, consider the case where two patches are being merged, if both patches are controlled by two different controllers, a merge operation will require the syndrome generation cycles for both patches to be in lockstep. If one controller is lagging behind the other, then the patch controlled by the leading controller will incur decoherence errors while the lagging patch catches up. A lack of synchronization between controllers thus results in longer surface code cycles during multi-patch operations and a higher likelihood for decoherence errors to affect the patches.

Non-uniform gate latencies, non-deterministic decoding latencies, and imperfect timing between controllers make it necessary to have synchronization policies within and between logical patches. System 100 provides the technical benefit of reducing idling errors due to decoherence, which affects the performance of the surface code.

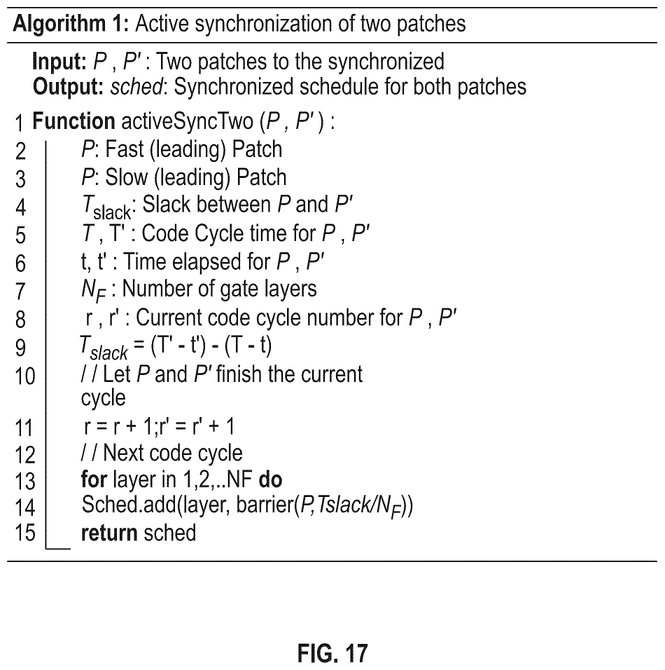

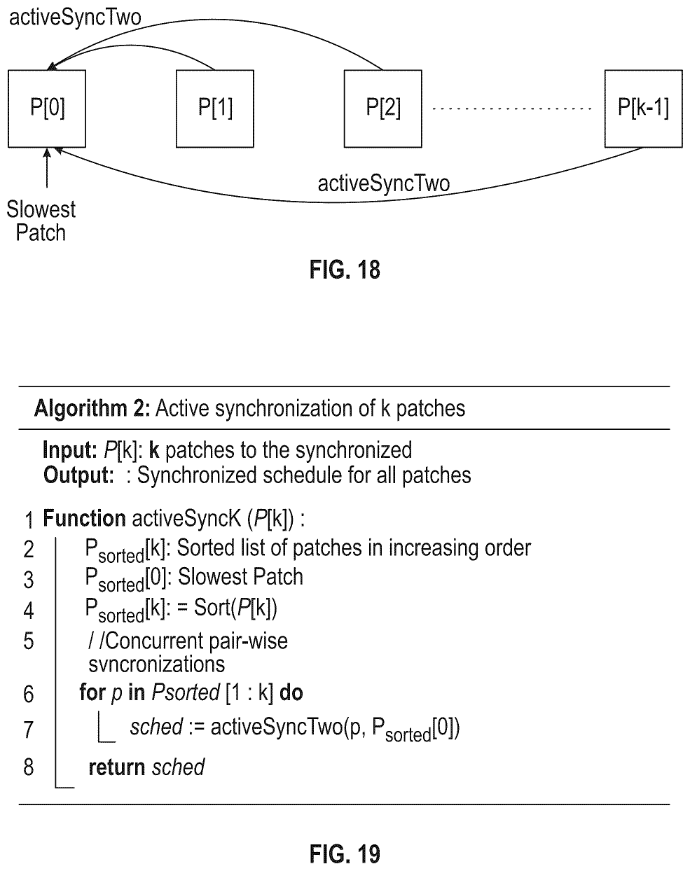

To illustrate how patches can get desynchronized, consider the example shown in FIG. 14 which shows the consumption of two magic states |m₁₋₂ [symbol] by an arbitrary quantum state |ψ [symbol] . Let us assume that at step 1401, all patches are synchronized. Step 1402 is the multi-body measurement via lattice surgery that performs a Z⊗Z measurement. The result of this measurement, as well as the measurement of |m₁ [symbol] is used to determine the Clifford corrections in step 1403. Now, before the next operation can be performed in step 1404, all errors for the patch with the initial state of |ψz,21 is known. This implies that to determine the correction C at step 1403, errors will have to be decoded for all rounds before and after the lattice surgery operation of step 1402. This further implies that there should be no undecoded rounds between steps 1403 and 1404, since decoding takes a finite amount of time, patch |ψ [symbol] will have to start a new round R after step 1402 until the correction is known. At this time, |ψ [symbol] and |m₂ [symbol] are still synchronized. Now after round R is completed, the decoder needs some time to decode the syndromes generated in that round, at this point, there are two options: (a) both |ψ [symbol] and |m₂ [symbol] can wait for the decoder to finish (this will be a relatively short wait since the decoder has to process the information of one additional round of error correction) or, (b) start another round. If option (b) is chosen, the decoder will have to decode the second additional round as well—the finite time taken by the decoder will lead to a deadlock where computation cannot continue to step 4 until all rounds are decoded, but the decoder keeps getting more rounds to decode. Even if all other operational latencies are uniform, FIG. 15 shows that decoder latencies are highly non-deterministic, which makes it hard to predict which round the decoder will be able to process syndromes quickly enough. Thus, if option (a) is chosen, it becomes much easier to continue with the computation. However, this will lead to patches |ψ [symbol] and |m₂ [symbol] being out of sync. with the rest of the system. Despite efforts to reduce decoding latencies, achieving deterministic latencies remains challenging. For example, the latencies reported were averaged over 100,000 trials and normalized over d rounds. Additionally, delays in routing syndrome measurements and conditional operations based on decoding outcomes can increase non-determinism.

For lattice surgery operations involving non-Clifford states, reducing the errors incurred during synchronization is helpful because post-merge, the merged patch is a new surface code patch that has more physical qubits but the same code distance. This makes it more susceptible to errors, and hence the decoding after lattice surgery is required to determine the appropriate correction. If idling during synchronization introduces additional errors to P/P′, there will not be enough correction capability post lattice surgery to correct these accumulated errors and the errors incurred during syndrome generation and measurement on the new merged patch.

It is possible to reduce the worst-case slack by rolling back the gates applied on the slower patch. For example, if the slower patch P′ was executing the first layer of Hadamard gates while P was finishing the final measurement layer, the slack could be reduced to just the sum of the difference in decoding latencies and the latency of a Hadamard gate since the first layer of Hadamards can be unrolled. However, this approach is feasible only if the patch in question recently finished at least d rounds of measurements to ensure that the control software has relatively recent information on the errors affecting that patch. As this may not always be the case, the worst-case slack is thus the case where both patches are at either end of the code cycle.

The simplest way of synchronizing two patches would be to have the faster (leading) patch wait for the slower (lagging) patch before starting the lattice surgery operation (since the cycle duration cannot be reduced for a patch). For example, patch P will have to wait for P′ to finish its cycle and decoding before the lattice surgery operation can proceed. This approach is called passive synchronization. A disadvantage of this approach is that the faster patch (P) will be idle before the lattice surgery operation starts—data qubits will not be protected by stabilizer operations during this period. While techniques like Dynamical Decoupling (DD) can be used to reduce the impact of idling (decoherence) errors, they can only mitigate such errors, not eradicate them. Secondly, a DD sequence has a finite duration, and using a number of DD sequences may not be sufficient to completely cover the idle duration of the faster patch. Thirdly, DD sequences are physically applied on hardware and are not error-free - this reduces their efficacy in reducing idling errors. Idling errors constitute a significant portion of the total error budget despite the use of DD. Finally, DD sequences were calibrated per data qubit to optimize performance which is not a scalable approach for optimizing DD the number of logical qubits is increased. The goal is thus to augment DD for countering idling errors during synchronization. Certain aspects of the present disclosure may include some, all, or none of the above advantages and/or one or more other advantages readily apparent to those skilled in the art from the drawings, descriptions, and claims included herein. Moreover, while specific advantages have been enumerated above, the various aspects of the present disclosure may include all, some, or none of the enumerated advantages and/or other advantages not specifically enumerated above.

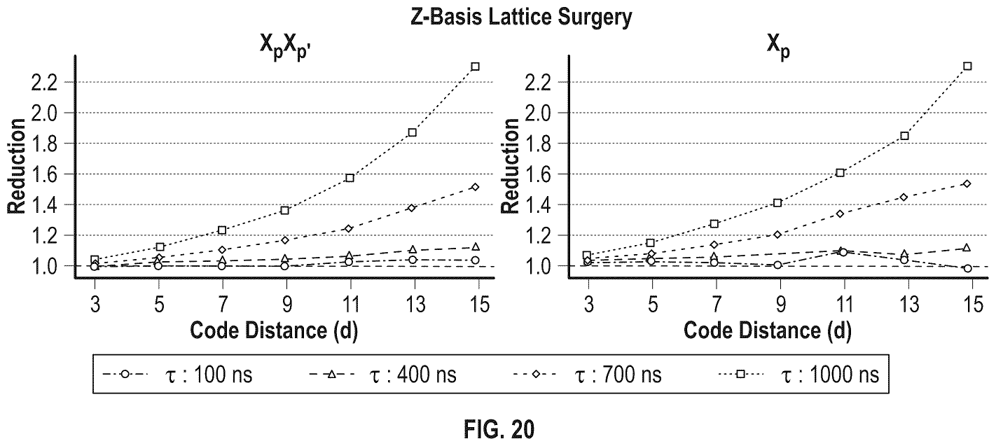

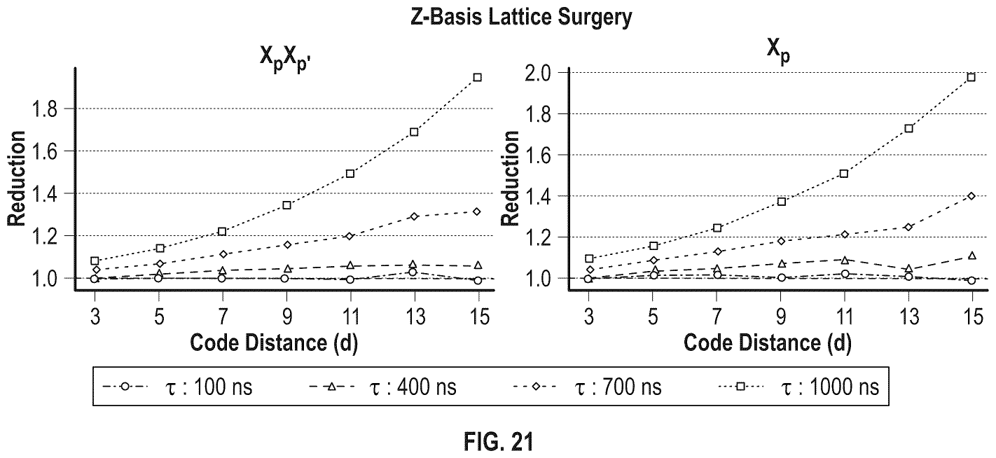

FIGS. 16 and 17 illustrate an algorithm for active synchronization of two patches. Active synchronization attempts to decrease the impact of idling errors on the logical error rate by inserting the synchronization slack within a code cycle. System 100 utilizes an active synchronization that uses an additional round of syndrome measurement to absorb the synchronization slack before the final syndrome measurements and decoding. The key insight behind this approach is that by introducing the idle periods required for synchronizing the two patches within an additional surface code cycle, it will be possible to identify some or most of those errors during the subsequent decoding of the syndrome measurements, thus limiting the idle period experienced by the data qubits outside an active code cycle to the absolute minimum. This approach augments DD since breaking the synchronization slack into shorter durations reduces the impact of idling errors as longer idle periods accumulate more decoherence errors even with the use of DD. Algorithm 1 (FIG. 17) describes the process of active synchronization. The total slack between the patches is determined by finding the difference between time left in completing the code cycle of both patches. This slack is divided equally between the number of gate (N_{F}) layers of the schedule in the form of a blocking barrier.

Algorithm 1 is visualized in FIG. 16 where the synchronization slack is (i) added to the end of the final code cycle (after syndrome measurement) for passive synchronization, and (ii) distributed within the final code cycle for active synchronization. Algorithm 1 ensures that the patches being synchronized enter the decoding stage at the same time. However, this does not mean that they will remain synchronized after decoding is complete, due to the non-deterministic decoding latency of every patch. To remedy this, the decoding latency for both patches can be fixed (at the cost of a possible temporary increase in the number of undetected errors) or the use of passive synchronization where the patch decoded first waits for the second patch. The progress being made in designing accurate and faster decoders makes the former a more attractive solution for the final synchronization step.

Thus far, it is assumed that active synchronization needs an extra round for synchronization. However, this is not entirely necessary. As the required lattice surgery operations are known at compile time, synchronization can easily schedule an entire code cycle in advance, eliminating the need for an extra code cycle.

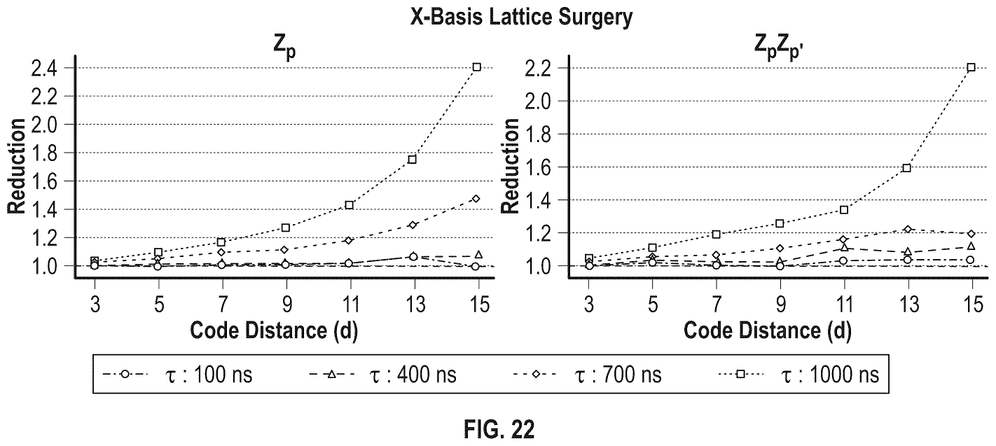

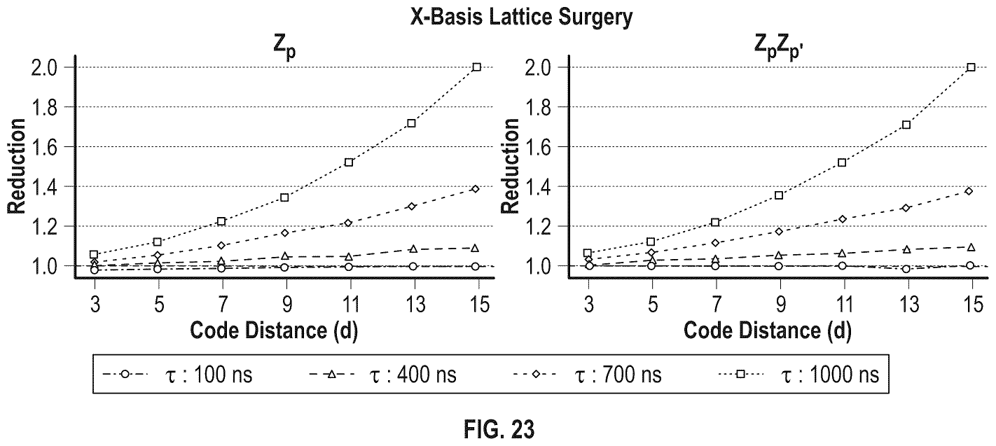

Referring to FIGS. 18 and 19 an algorithm for generalizing the two-patch synchronization algorithm to an arbitrary number of patches is shown. Multi-patch operations require the synchronization of more than two patches. Multi-patch operations require an extended synchronization mechanism that can synchronize an arbitrary number of patches. The simplest, passive approach would be to have all patches complete their code cycles and wait for every other patch to finish before starting the lattice surgery operation. While some patches could have a negligible slack between them (due to prior synchronizations), the worst-case synchronization slack would be the same as the two patch case.

Algorithm 2 (FIG. 19) generalizes the two-patch synchronization algorithm to an arbitrary number of patches by identifying the slowest patch after sorting the patches based on the time needed for them to complete their current code cycle and then performing pair-wise synchronizations using Algorithm 1 of all the patches with the slowest patch. As shown in FIG. 18, all pair-wise synchronizations can be performed in parallel, which makes the synchronization of an arbitrary number of patches take constant time.

Active synchronization does not reduce the total idling period required to synchronize N patches, by inserting idle periods within a code cycle, it aims to introduce any and all idling errors before the final round of syndrome measurements before the lattice surgery operation. Doing so gives the decoder a chance to detect idling errors that occurred during the synchronization before the merge operation. On the contrary, passive synchronization results in accumulated errors due to idling remaining undetected until the first syndrome measurement after the merge operation. The additional errors incurred due to passive synchronization indirectly affect the performance of the system—an increase in errors increases the effort required from the decoder to detect errors accurately. By increasing the circuit-level error rate from the nominal error rate of about 10⁻⁴, the decoding latency averaged over 10 M shots can increase by more than about 40% for an increase of about 20% in the error rate.

These results show that an increase in the error rate for a logical qubit will result in subsequent decoding latencies being higher, since the decoder is presented with harder to decode errors. Furthermore, a logical qubit protected by the surface code cannot remain fault-tolerant indefinitely—as the decoder latency increases due to accumulated errors, the slowdown of the system will cause a reduction in the efficacy of the code. Compared to active synchronization, passive synchronization will negatively impact system performance, as a higher error rate post-merge will increase the decoding latency of the merged patch. Considering the large number of T states required by applications and the fact that the consumption of every T state requires at least one CNOT (and thereby at least one merge operation), this slowdown will accumulate very quickly for passive synchronization.

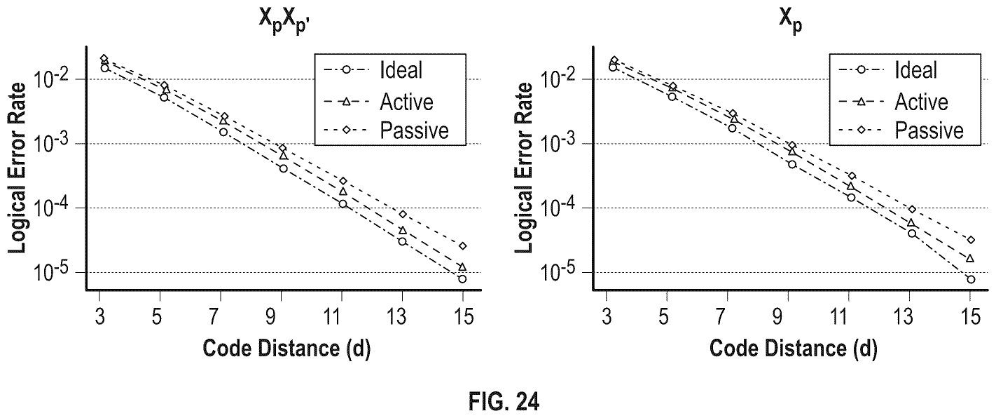

FIGS. 20-23 illustrate the improvements in the logical error rate when using the active synchronization of system 100. To quantify the benefits of active synchronization, some system-level parameters have to be chosen to emulate a realistic system. These parameters include gate latencies, measurement and reset latencies, and the relaxation (T1) and decoherence times (T2) of the qubits in the system. In evaluations, simulations were ran using two execution configurations: a first configuration (e.g., the first for a system with IBM®-like parameters) and a second configuration (e.g., the second for a system with Google®-like parameters). The final parameter that was varied for both configurations was the synchronization slack (τ), which defines how far apart in time the two patches being synchronized are. Since the worst-case slack between two patches is the code cycle time, the synchronization slack τ from 100 ns to 1000 ns was varied. These values were chosen since code cycle times for Google® and IBM®-like systems are about 1 μs and 2 μs respectively. The results for two-patch synchronization hold true for synchronizing N patches, as the latter is a generalized case of two-patch synchronization.

For the first configuration, it is assumed that two-qubit gates have a latency of 200 ns, measurement and reset take 500 ns, and the T1 and T2 times are 250 μs, 150 μs respectively. FIG. 20 illustrates the improvement in the logical error rate for both Z and X basis lattice surgery with the use of active synchronization over passive, resulting in an improvement of up to about 2.4 times. Active synchronization generally performs better with a larger synchronization slack, thus highlighting the benefits of active synchronization. Furthermore, since synchronization is performed on the d+1th round for both active and passive policies, the improvements of active synchronization come after running an additional d+1 rounds with the merged patch for both policies.

For the second configuration, it is assumed two-qubit gates have a latency of about 50 ns, measurement and reset take 660 ns, the T1 time is 25 μs, and the T2 time is 40 μs. FIG. 21 illustrates the improvement offered by active synchronization for both Z and X basis lattice surgery, achieving an improvement of up to 2.1 times.

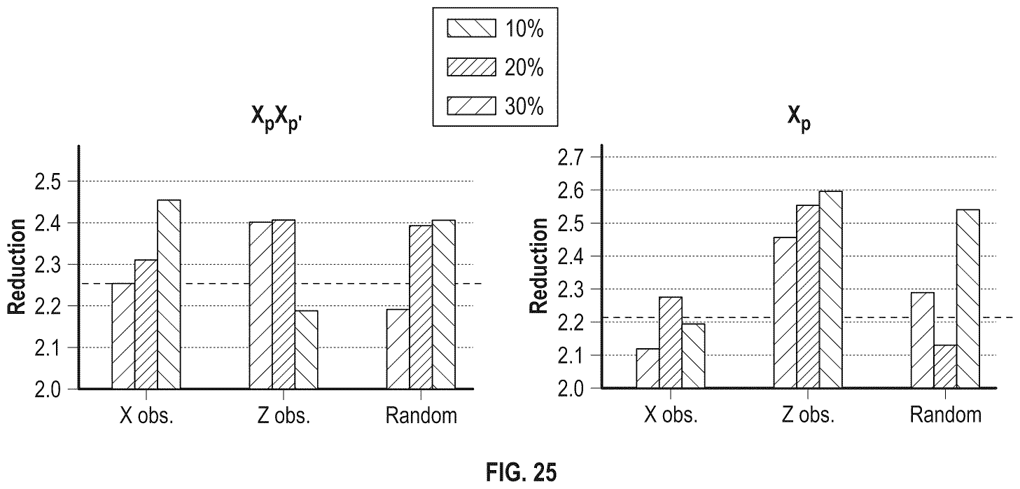

FIG. 24 illustrates the logical error rate for three systems: an ideal system that requires no synchronizations, a system using the passive policy, and a system using the active policy. For a worst-case synchronization slack of 1000 ns, active synchronization can achieve a logical error rate that is much closer to the ideal system as compared to the passive policy, thus highlighting its effectiveness as a synchronization policy. In a multi-node quantum computer, lattice surgery operations will likely span node boundaries, which will be connected with slower links. In this scenario, the slack (τ) can be much higher due to longer CNOT latencies between node boundaries, and evaluations show that active synchronization can achieve a 2-3x× improvement over passive synchronization for d=13, 15 (τ=2000 ns). Process or manufacturing defects in superconducting qubits can result in some qubits in the lattice having shorter T1 and/or T2 times. For example, in IBM Brisbane®, the median T2 time is 150 μs but the smallest T2 time is about 16 μs.

To evaluate how such defects affect the efficacy of active synchronization, defects were inserted in d qubits for both patches P and P′. Three configurations were created: 1) d qubits of the XP and XP′ observables, 2) d qubits of the ZP and ZP′ observables, and 3) 2d qubits randomly selected from both patches. In the random configuration, both data and measure qubits can be selected.

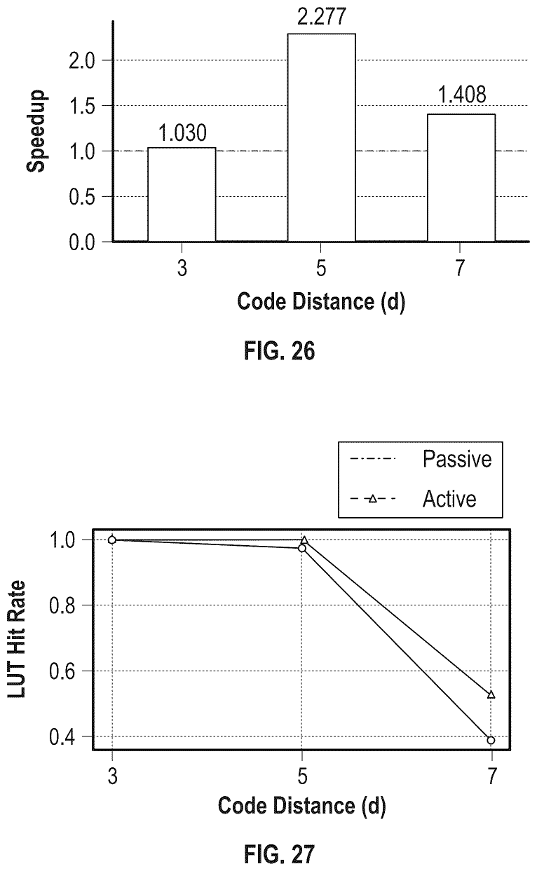

FIG. 25 illustrates the improvement in the logical error rate compared to an ideal case where there are no defects in the lattice (for Z basis lattice surgery). In general, the benefit of active synchronization increases as the magnitude (decrease in T1 and T2) of the defect increases, thus highlighting its efficacy.

Higher error rates increase the decoder effort and, thus, the decoder latency. Active synchronization outperforms passive synchronization in terms of the logical error rate. To evaluate the benefit of using active synchronization, a hierarchical decoder was considered where the fast, low-overhead decoder was a lookup table (LUT) based decoder and the slow, accurate decoder was the standard MWPM decoder. If a syndrome missed the LUT, the MWPM decoder was invoked, thus requiring more time for the error to be decoded. As a LUT of infinite size is not practical, the size was limited to 3 KB, 3 MB, and 30 MB for d=3, 5, 7 respectively (beyond d=7, the LUT size required is impractical).

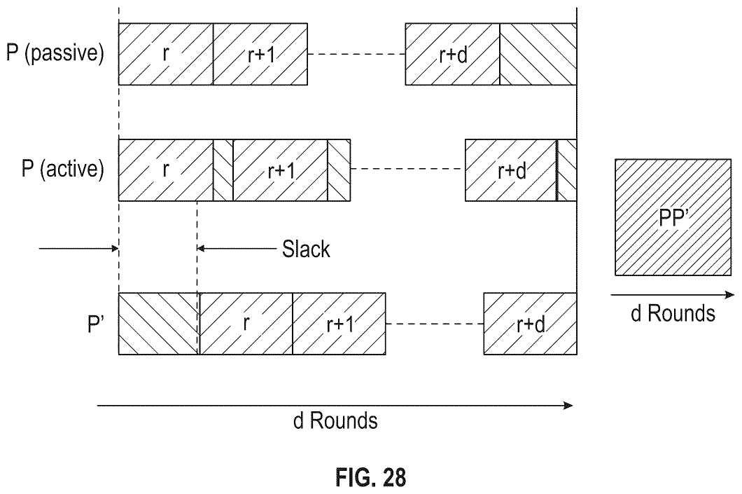

FIGS. 26 and 27 illustrate the relative speedup of active synchronization over passive synchronization due to the reduction in error rate (and hence the reduction in hard to decode errors). This speedup was determined numerically over 1B trials with the assumption that a hit in the LUT incurs a decoding latency of about 20 ns while a miss invokes the MWPM decoder, whose latency is sampled from a MWPM latency dataset. For d=3, the LUT was able to capture almost all possible syndromes for both cases, thus yielding a small speedup of 0.3%. However, for d=5, the speedup is more than 2.2× as more syndromes hit in the LUT in the case of active synchronization. For d=7, the hit rate of the LUT is significantly lower, reducing the overall speedup offered by active synchronization, as shown in FIG. 26.

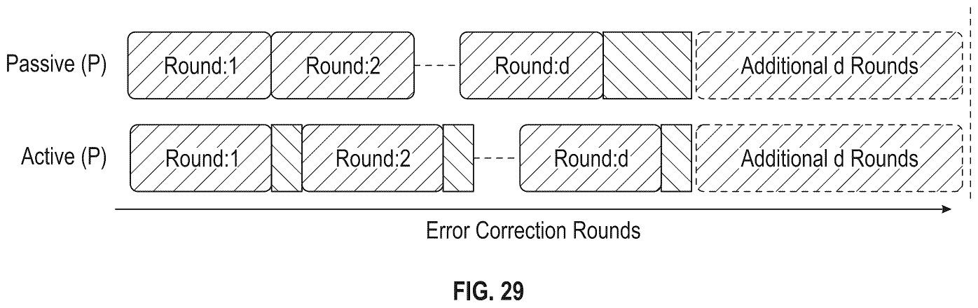

FIGS. 28 and 29 illustrate performing synchronization by distributing the slack between multiple cycles using the system 100 of FIG. 1. System 100 is not only able to use active synchronization to distribute the slack within a code cycle, but also can use active synchronization to distribute the slack between multiple cycles. In the context of quantum error correction, a “round” refers to a complete cycle of operations involved in detecting and correcting errors in a quantum system. Referring to FIG. 28, patch P starts round r before patch P′ so that in active synchronization the slack is distributed evenly between the d rounds, while in passive synchronization, the slack is added at the end of the last round before synchronization and Lattice Surgery. FIG. 29 is an example showing the difference between active and passive synchronization—patch P is run for d rounds while the slack is added between (active) or after all (passive) rounds. P is then run for another d rounds before decoding. FIG. 29 shows an example of how the process of breaking the synchronization slack into smaller chunks and inserting it between rounds reduces the number of errors. To emulate passive synchronization, d code cycles of a distance d patch P are run before appending a slack (for example, about 500 ns or 1000 ns) and then running an additional d rounds. For active synchronization, the idle period is broken into smaller chunks and inserted between rounds. All syndromes are then decoded after 2d rounds. With this setup, we see over 100,000 shots that the active method reduces the number of undetectable errors for different code distances, as shown in Table 1 (p=10−3, T1=25□s, T2=40□s).

For example, the processor may cause the system 100 to perform the steps of: determining a synchronization slack between two or more logical patches of a quantum computer that are to undergo a lattice surgery operation; determining a time elapsed in a code cycle for a logical patch of the two or more logical patches; generate patch counter information, wherein the patch counter information includes a number of rounds completed for the two or more logical patches; accessing, by a synchronization engine, patch counter information and patch metadata from a patch metadata table and the patch counter table of the two or more logical patches, wherein the patch metadata includes a cycle duration of every logical patch; determining by the synchronization engine the synchronization slack to be added to a schedule; determining the difference in an execution phase of the patches through a phase calculator to determine a fastest patch and a slowest patch; and performing a correction by synchronizing the two or more logical patches based on inserting, by a synchronization slack calculator, a barrier in the schedule, based on the determined fastest patch and slowest patch. The barrier (e.g., the idle period to be inserted) is broken into a plurality of portions and each is inserted between rounds. For example, all syndromes may then be decoded after 2d rounds.

The aspects disclosed herein are examples of the disclosure and may be embodied in various forms. For instance, although certain aspects herein are described as separate aspects, each of the aspects herein may be combined with one or more of the other aspects herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an aspect,” “in aspects,” “in various aspects,” “in some aspects,” or “in other aspects” may each refer to one or more of the same or different example aspects provided in the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances. The aspects described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. A system for logical patch synchronization, comprising:
a quantum computer;
a processor; and
a memory, with instructions stored thereon, which when executed by the processor cause the system to:
determine a synchronization slack between two or more logical patches of the quantum computer that are to undergo a lattice surgery operation;
determine a time elapsed in a code cycle for a logical patch of the two or more logical patches;
generate patch counter information;
access, by a synchronization engine, patch counter information and patch metadata from a patch metadata table of the two or more logical patches, wherein the patch metadata includes a cycle duration of every logical patch;
determine by the synchronization engine the synchronization slack to be added to a schedule;
determine the difference in an execution phase of the patches through a phase calculator to determine a fastest patch and a slowest patch; and
perform a correction by synchronizing the two or more logical patches based on inserting, by a synchronization slack calculator, a barrier in the schedule, based on the determined fastest patch and slowest patch.

2. The system of claim 1, wherein the instructions, when executed by the processor, further cause the system to:
distribute the synchronization slack within the code cycle by interleaving gates and idle periods.

3. The system of claim 1, wherein the instructions, when executed by the processor, further cause the system to:
determine the synchronization slack between the two or more logical patches by finding a difference between a time left in completing the code cycle of the two or more logical patches,
wherein the slack is divided equally between a number of gate layers of the schedule in the form of a blocking barrier.

4. The system of claim 1, wherein the system maintains a counter for every logical patch.

5. The system of claim 4, further comprising a counter for each logical patch, and wherein the instructions, when executed by the processor, further cause the system to:
increment each counter at every tick of a global clock;
start and end each counter with a surface code cycle for its corresponding patch;
merge or split a patch to yield one or more different patches; and
disable the respective counter for a former patch.

6. The system of claim 1, wherein the instructions, when executed by the processor, further cause the system to:
update the patch metadata after every lattice surgery operation of a plurality of lattice surgery operations.

7. The system of claim 6, wherein the instructions, when executed by the processor, further cause the system to:
perform the correction after every lattice surgery of the plurality of lattice surgery operations based on the updated patch metadata.

8. The system of claim 1, wherein the patch counter information includes information on bit validity indicating whether the logical patch is a valid logical patch or an invalid logical patch.

9. The system of claim 1, wherein the instructions, when executed by the processor, further cause the system to:
introduce idle periods required for synchronizing the two or more logical patches within an additional surface code cycle.

10. The system of claim 1, wherein the patch counter information includes a number of rounds completed for the two or more logical patches.

11. A processor-implemented method for logical qubit synchronization, comprising:
determining a synchronization slack between two or more logical patches of a quantum computer that are to undergo a lattice surgery operation;
determining a time elapsed in a code cycle for a logical patch of the two or more logical patches;
generating patch counter information, wherein the patch counter information includes a number of rounds completed for the two or more logical patches;
accessing, by a synchronization engine, patch counter information and patch metadata from a patch metadata table and the patch counter table of the two or more logical patches, wherein the patch metadata includes a cycle duration of every logical patch;
determining by the synchronization engine the synchronization slack to be added to a schedule;
determining the difference in an execution phase of the patches through a phase calculator to determine a fastest patch and a slowest patch; and
performing a correction by synchronizing the two or more logical patches based on inserting, by a synchronization slack calculator, a barrier in the schedule, based on the determined fastest patch and slowest patch.

12. The processor-implemented method of claim 11, further comprising:
distributing the synchronization slack within the code cycle by interleaving gates and idle periods.

13. The processor-implemented method of claim 11, further comprising:
determining the synchronization slack between the two or more logical patches by finding a difference between a time left in completing the code cycle of the two or more logical patches,
wherein the slack is divided equally between the number of gate layers of the schedule in the form of a blocking barrier.

14. The processor-implemented method of claim 11, further comprising:
maintaining a counter for every logical patch.

15. The processor-implemented method of claim 14, further comprising:
incrementing a counter for each logical patch at every tick of a global clock;
starting and ending each counter with a surface code cycle for its corresponding patch;
merging or splitting a patch to yield one or more different patches; and
disabling the respective counter for a former patch.

16. The processor-implemented method of claim 11, further comprising:
updating the patch metadata after every lattice surgery operation of a plurality of lattice surgery operations.

17. The processor-implemented method of claim 16, further comprising:
performing the correction after every lattice surgery of the plurality of lattice surgery operations based on the updated patch metadata.

18. The processor-implemented method of claim 11, wherein the patch counter information includes information on bit validity indicating whether the logical patch is a valid logical patch or an invalid logical patch.

19. The processor-implemented method of claim 11, further comprising:
introducing idle periods required for synchronizing the two or more logical patches within an additional surface code cycle.

20. A non-transitory computer readable medium storing a program that causes a computer to execute a processor-implemented method for logical qubit synchronization, comprising:
determining a synchronization slack between two or more logical patches of a quantum computer that are to undergo a lattice surgery operation;
determining a time elapsed in a code cycle for a logical patch of the two or more logical patches;
generating patch counter information, wherein the patch counter information includes a number of rounds completed for the two or more logical patches;
accessing, by a synchronization engine, patch counter information and patch metadata from a patch metadata table and the patch counter table of the two or more logical patches, wherein the patch metadata includes a cycle duration of every logical patch;
determining by the synchronization engine the synchronization slack to be added to a schedule;
determining the difference in an execution phase of the patches through a phase calculator to determine a fastest patch and a slowest patch; and
performing a correction by synchronizing the two or more logical patches based on inserting, by a synchronization slack calculator, a barrier in the schedule, based on the determined fastest patch and slowest patch.

21. A system for logical patch synchronization, comprising:
a quantum computer;
a processor; and
a memory, with instructions stored thereon, which when executed by the processor cause the system to:
determine a synchronization slack between two or more logical patches of the quantum computer that are to undergo a lattice surgery operation;
determine a time elapsed in a code cycle for a logical patch of the two or more logical patches;
generate patch counter information;
access, by a synchronization engine, patch counter information and patch metadata from a patch metadata table of the two or more logical patches, wherein the patch metadata includes a cycle duration of every logical patch;
determine by the synchronization engine the synchronization slack to be added to a schedule;
determine the difference in an execution phase of the patches through a phase calculator to determine a fastest patch and a slowest patch; and
perform a correction by synchronizing the two or more logical patches based on inserting, by a synchronization slack calculator, a barrier in the schedule, based on the determined fastest patch and slowest patch,
wherein the barrier is subdivided into a plurality of portions based on a number of rounds and each of the plurality of portions is inserted between rounds.
